(19) United States
(12) Patent Application Publication
(10) Pub. No.: US 2025/0225058 A1
(43) Pub. Date: Jul. 10, 2025

(54) Dynamic problem detection in microservice architecture

(71) Applicant: Ciena Corporation, Hanover, MD (US)

(72) Inventors: Emily Michelle Mulvihill, Ottawa (CA); David Miedema, Ottawa (CA); Aaron Gregory Seilis, Port Moody (CA); Olivier Brodeur, Québec City (CA); Hadi Dewan, Stittsville (CA)

(73) Assignee: Ciena Corporation, Hanover, MD (US)

(21) Appl. No.: 18/409,379

(22) Filed: Jan. 10, 2024

(51) Int. Cl. G06F 11/36

(52) U.S. Cl. CPC G06F 11/366

(57) ABSTRACT

Systems and methods for troubleshooting software within a network microservices architecture are provided. A method, according to one implementation, includes the step of obtaining log information from a plurality of customer level devices and microservices in a network. The method also includes the step of converting the log information into data having a common format. Also, the method includes analyzing the data to determine issues with respect to the microservices. The method further includes the step of publishing an accessible notice to allow software troubleshooting of the issues with respect to the microservices.

### TECHNICAL FIELD

The present disclosure generally relates to networking systems. More particularly, the present disclosure relates to systems and methods for dynamically detecting issues in microservices and posting notices to enable remediation of the issues.

### BACKGROUND

In traditional systems for detecting problems in a network, a logging system may be used to collect data in the form of log data. However, the relevant information in this log data is usually too detailed and unstructured, which can make it difficult for an automated system to parse and use. Some complex systems may be configured to add log exportation and analysis (e.g., indexing) for searching through the logs to try to find problems in the network. On an end-user level, the log data is mostly consumed by users for troubleshooting their own network equipment (e.g., laptop, mobile phone, etc.). One typical problem with log data in this case is that, when a log queue (having an arbitrarily set logging capacity) fills up on a device, the old data is flushed out and crucial details can be lost. An IT professional may use the log data to troubleshoot issues on an end user's device in the hope that relevant information will be there to help diagnose issues. They might also use this data, along with log data from other devices, to diagnose what might actually be a system wide problem. This entire process can be an especially time-consuming task in that a human must go through this unstructured log data obtained from one or more devices. It can be difficult for the technician to analyze different formats of log data from multiple devices in order to get a usable system snapshot. Some known solutions that exist to help diagnose log data require offloading logs to a cloud where analytics can be performed. However, these solutions usually perform post processing, which is not always a good solution, especially where security concerns may not allow for offloading logs.

### BRIEF SUMMARY

In various embodiments, the present disclosure includes methods having executable steps, systems including at least one processor and memory with instructions that enable the at least one processor to implement the executable steps, and/or non-transitory computer-readable media having instructions stored thereon for programming at least one processor to perform the executable steps. The executable steps in the present disclosure are related to dynamically troubleshooting software in a microservices environment.

According to one implementation, a method for testing microservices of a network includes the step of obtaining log information from a plurality of customer level devices and microservices in a network. The method further includes converting the log information into structured data having a common format. Also, the method includes the step of analyzing the structured data to determine issues with respect to the microservices. Furthermore, the method includes the step of publishing an accessible notice to allow software troubleshooting of the issues with respect to the microservices.

According to some embodiments, the published accessible notice allows a software developer to modify software associated with one or more of the microservices to reduce the issues thereof. The step of obtaining the log information may be performed at runtime after the microservices have been deployed in the network. The method may further include the step of storing the structured data in a database or memory device.

The step of publishing the accessible notice may include creating a bulletin in a bulletin board system that is accessible by other devices on the network. The bulletin board system, for example, may allow access to multiple accessible notices by one or more vendors, developers, network operators, admins, and network designers for the purpose of troubleshooting. The bulletin board system may also allow access at both a static design stage before deployment and a dynamic operational stage after deployment. The customer level devices, for example, may include one or more embedded devices.

The accessible notice described herein may also include a) instructions, b) next-steps, c) reference to additional documents or resources, d) root cause analysis, e) suggestions, and/or f) recommendations, regarding remediation of the issues with respect to the microservices. The method, according to some implementations, may further include the step of utilizing a tracking ID for monitoring the execution of remediation steps. The issues with respect to the microservices may include a) formatting issues, b) software bugs, c) storage or filesystem issues, d) misconfiguration issues, e) configuration reading issues, f) communication issues, g) improper use of system resources, h) issues with communicating with system resources, i) disabled system features, j) noisy log information, and/or k) irrelevant log information. The method may also be configured to automatically remediate the issues with respect to the microservices.

In some embodiments, the method may include the steps of 1) collating a plurality of accessible notices across multiple microservices and 2) creating a system level report. Upon detection of an issue, the method may further include the step of initiating an enhanced data collection mode for obtaining log information at a greater resolution for a predetermined amount of time. In some embodiments, the method may also include the step of invoking one or more Remote Procedure Calls (RPCs) from related devices to initiate self-diagnosis or self-healing stages without the need for user intervention.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram illustrating details of different forms of software testing.

FIG. 2 is a diagram illustrating a network where software testing can be performed at a customer level and/or system level, according to various embodiments of the present disclosure.

FIG. 3 is a block diagram illustrating the test system shown in FIG. 2, according to various embodiments.

FIG. 4 is a block diagram illustrating the troubleshooting program shown in FIG. 3, according to various embodiments.

FIG. 5 is a diagram illustrating an example of a bulletin board where notices can be posted, according to various embodiments.

FIG. 6 is a flow diagram illustrating a method for testing microservices of the network/cloud shown in FIG. 2, according to various embodiments.

### DETAILED DESCRIPTION

### Software Testing

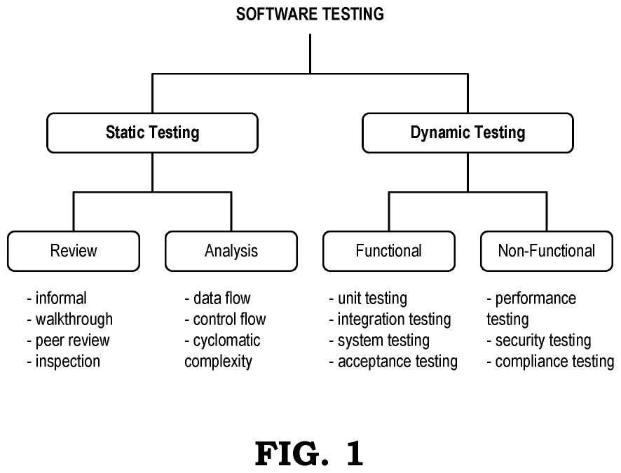

FIG. 1 is a chart showing various details of software testing. For example, software testing may include static testing and/or dynamic testing. Static testing refers to the analysis of software code before the code is actually executed. Dynamic testing refers to the analysis of the software code while the code has been deployed and is executing.

Furthermore, static testing may include a review stage and an analysis stage. The review stage may include an informal inspection of the code, a walkthrough inspection, a peer review or “second eye” of the code from software experts, and/or a formal inspection step. The analysis stage may include the analyzing of the code to observe the data flow, observe the control flow, and/or to analyze the cyclomatic complexity of the code. The evaluation is done to find any structural defects that could lead to errors when the program runs. Instead of executing the code, static testing involves checking the code to find errors before the program runs and designing documents and requirements accordingly. One goal during this process is to find flaws in the early stages of development, which can normally be easier to discover.

Informal reviews will not follow any specific process to find errors. For example, co-workers can review documents and provide informal comments. Walk-through may include the coder or program author to explain the code and documentation to their team or peers. Team participants can ask questions. Technical or peer reviews can include reviewing technical specifications by peers to detect any errors. Inspection may involve a designated moderator who can conduct a strict review as a process to find defects.

Dynamic testing, for example, may include a functional stage and a non-functional stage. The functional stage may include unit testing, integration testing, system testing, and/or acceptance testing. The non-functional stage may include performance testing, security testing, and/or compliance testing. The code is compiled and run in any suitable computing system or operating system. Dynamic testing assesses the feasibility of a software program by giving input and examining output.

In a network environment, software testing (e.g., the testing form shown in FIG. 1) may include the static and dynamic analysis of code operating within microservices and/or other functionality throughout the network. Microservices, for example, may refer to software functionality that is part of service-oriented or server-oriented components for providing server-client services to end users. The microservices may include a plurality of computer applications arranged throughout the network for executing unified functions and/or unrelated functions. The microservices may include a collection of loosely coupled, fine-grained services, communicating through lightweight protocols.

In some respects, network designers and/or software developers may create a network, sub-network, enterprise domain, etc. by deploying microservices to ensure that end users can be serviced as planned. One strategy for these teams may be to develop and deploy their services independently of others. For example, this can be achieved by the reduction of several dependencies in the code base, allowing developers to evolve their services with limited restrictions from users. As a result, networks can be built to scale and developed more easily. Referring again to FIG. 1, the microservices in a network can include software that is tested in a static or dynamic manner. That is, the microservice code can be tested before deployment (“static”) in the network as well as after deployment (“dynamic”).

Static testing is a software testing method that examines a program or application (along with associated documents) but does not require the program to be executed on physical computing devices. On the other hand, dynamic testing usually includes interaction of the program with an Information Technology (IT) professional or with the end-user himself or herself. Thus, the tester may interact with the program while it is running. The two methods are frequently used together to ensure the basic functionalities of a program.

Furthermore, static testing can be performed using a “linter” or linting tool to help improve the code. This can be done by analyzing the source code looking for problems. One goal of a linter is to analyze the source code to come up with compiler optimizations. However, linters are not restricted to compiled languages, but can be used with respect to any languages since there is no compiler used to detect errors at this stage of software development. For example, linters may be configured to enable optimization for compilers, provide various checks, detect syntax errors, determine if the code adheres to specific standards, perform security checks, among other things.

### Troubleshooting Approaches

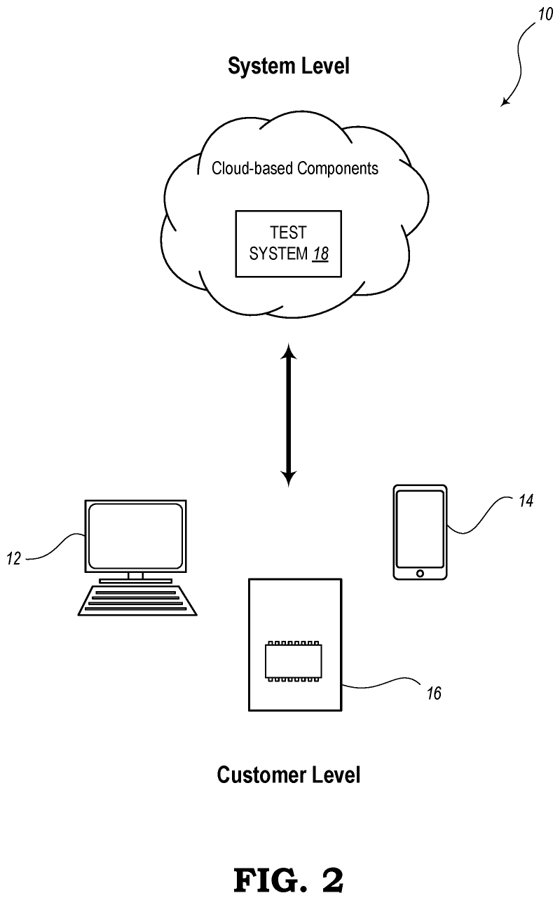

FIG. 2 is a diagram illustrating an embodiment of a network 10 (or sub-network, domain, etc.). In particular, software testing can be performed in the network 10 at a customer level and/or at a system level. The network 10 may include a plurality of end user devices, such as computers 12 (e.g., desktop computers, laptop computers, tablets, etc.), mobile devices 14, embedded systems 16, etc. For example, embedded systems 16 may include Internet of Things (IoT) devices or other devices having computer components, microcontrollers, processing components, etc. incorporated within an electronic or electromechanical device. The network 10 may further include a network-related or cloud-related components. For example, the cloud may include servers (not shown), microservices (e.g., executed by the servers), and a test system 18 for diagnosing issues with respect to the end user devices and/or microservices. The test system 18 may obtain log data and process this data in a unique manner to enable a better and more efficient utilization for troubleshooting purposes.

The computers 12, mobile devices 14, embedded devices 16, etc. may include self-diagnostic functionality to enable the detection of issues in hardware and/or software, which may result in the creation of log data. It may be noted that many mobile devices 14 and embedded devices 16, for instance, may include a relatively small queue (e.g., first-in, first-out (FIFO) memory) for storing the log data. As is known with FIFO, when the storage component reaches its fullest capacity, old data is replaced with new data. Since many devices do not have a lot of room for logging data, important information that could be used for troubleshooting can be lost.

According to some embodiments, the test system 18 may be configured to perform static and dynamic hardware and software testing on the components of the network 10. In particular, the test system 18 can obtain log data from one or more components (e.g., end user devices, microservices, servers, etc.) and convert the log data into a standardized or consistent format that can be more easily managed than typical logging information. Also, the test system 18 can store the useful log information in a cloud-based database and perform various analytics on the data to discover issues, which may be restricted to a single device or may be system wide. The test system 18 can also automatically remediate the issues, when possible, and/or provide instructions to a user, IT professional, technician, network operator, etc. to correct the issues.

In addition, the test system 18 can utilize a Bulletin Board System (BBS), which is described in more detail below. For example, the test system 18 can publish or post bulletins, notices, etc. on the BBS, which allows subscribers (e.g., other microservices) to access information that can be relevant to its own operation.

Therefore, in signal transport and embedded systems, there may typically be two levels of troubleshooting and diagnostics that can be supported. First, customer level issues may include problems with signals or equipment that a user or IT professional may need to address to get the system working in proper condition. Usually, problems can be discovered by looking at log data, which typically includes a manual process since most conventional log data is presented in a human-readable format. Second, system level issues may include software bugs, misconfigurations, filesystem, communications issues, and/or other such problems.

Customer level issues can be detected problems with the network 10 in the normal course of operations. In some cases, these issues may be detected using a Simple Network Management Protocol (SNMP) trap or other suitable detection processes. Example conditions may include a) detection that a signal power is too low, b) detection of a fiber pinch, c) detection that a piece of equipment has failed, d) detection that a piece of hardware has been added or removed, etc. For customer level issues, the network 10 may generate diagnostics information in the form of an alarm or a trap that feeds into a ticketing system (e.g., part of the testing system 18) for a network operator to address.

The following is an example of alarm information that may be provided to the network operator:
id: 13
name: missing
resource: ciena-6500r-slots: slots 1
raise-time: 2023-06-29T14:42:15Z
alarm-state: enabled
cause: Circuit Pack Missing
condition-type: EQPT-MISSING
location: near-end
severity: major
service-impact: sa
additional-info: DLM C-Band 2×SFP

System level issues may normally be logged for a vendor (or network administrator) to be able to troubleshoot something after it has gone wrong. In some cases, there may be no actions that the end user might take to correct these issues since they are normally things that the system designers should address or bugs in otherwise normal behavior. The logs in this case may include a) unformatted or poorly formatted configurations, b) transient issues that might be undetectable after a certain amount of time since there are limits on the amount of storage and retention of log data, c) noisy log data and/or useful log data mixed with other irrelevant information or logs, d) symptomatic of other more complex “upstream problems,” etc.

In conventional systems, logs might normally be used only when a customer level problem is detected but cannot be recovered by the network operator. In this case, a next level of support (system level) may be needed. With respect to the embedded system 16 or other end user components having limited log storage capabilities, the logs will be limited in their lifetime due to the storage limits that the device has. Logs will rotate out and previous information will be lost. Another shortcoming with conventional systems that manage log data is that logs are neither standardized nor machine parsable. Logs are designed for humans to process only in the event that something else has gone wrong and more information is required. Also, conventional log data also suffers from an intractable problem (i.e., they are hard to control or deal with). Therefore, the embodiments of the present disclosure are configured to capture enough detail in the logs to make post-facto (i.e., after the fact) analysis. Also, the present embodiments are configured to store the relevant log information to overcome the issue with conventional systems in that they may quickly generate a lot of logs in a short amount of time while also overwriting useful earlier data.

To help with the conventional problems in a cloud application with microservices, for example, the test system 18 of the present disclosure is configured to process the logs by allowing log exportation from the end user devices and microservices to the test system 18. Then, the test system 18 can convert the various log formats into a uniform format that can be useful for troubleshooting. The test system 18 can process the log data using indexing software to help testers (e.g., network operators, admin, IT professional, end users, etc.) wade through the data. Again, this is usually not possible with embedded systems in conventional networking systems. In some implementations, the test system 18 may use Machine Learning (ML) to try and sift through logs to try and identify problems.

An additional problem with logs is that conditions that a system can detect and report in a log are not easily reportable through conventional test systems. That is, an error condition can be detected and reported via a log, but a testcase cannot easily detect if this log has been emitted by a downstream service, and even if it can detect this, it is not obvious what to do about the logged condition.

Typical conditions that may be self-detecting and normally reported in a log include a) misconfiguration of a system feature, b) improper use of resources, c) chronic failure to communicate to a system resource, d) errors reading configuration or deployment data/options, e) system level features that have not been enabled, etc. Each condition like this can be logged when detected, but these logs will be quickly flushed. It is also not normal for conventional test systems to sift through logs to look for keywords that indicate problems that should be reported. Log scraping is normally a bad idea since the log contents can change (i.e., they are not structured), it is an intensive use of system resources, and logs can be flushed quickly in noisy systems and make this type of detection difficult and unreliable.

### General Computing System

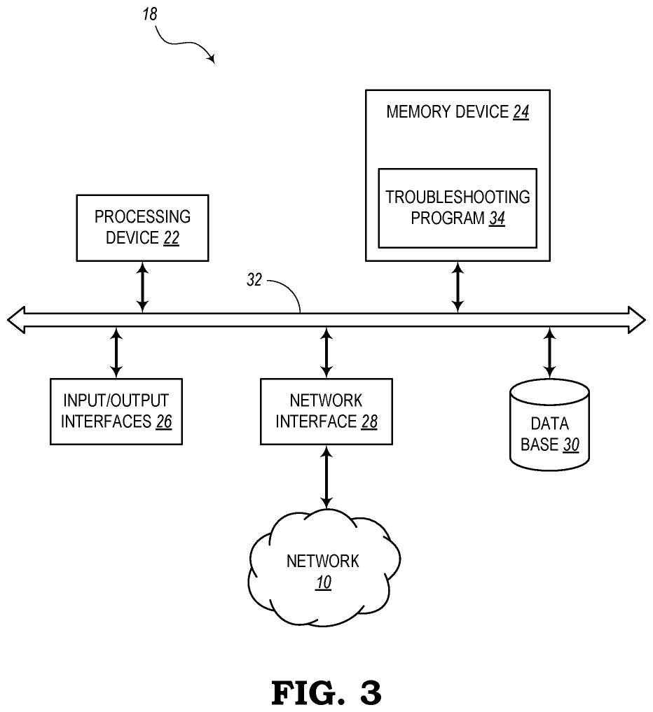

FIG. 3 is a block diagram illustrating an embodiment of the test system 18 shown in FIG. 2. In the illustrated embodiment, the test system 18 may be a digital computing device that generally includes a processing device 22, a memory device 24, Input/Output (I/O) interfaces 26, a network interface 28, and a database 30. It should be appreciated that FIG. 3 depicts the test system 18 in a simplified manner, where some embodiments may include additional components and suitably configured processing logic to support known or conventional operating features. The components (i.e., 22, 24, 26, 28, 30) may be communicatively coupled via a local interface 32. The local interface 32 may include, for example, one or more buses or other wired or wireless connections. The local interface 32 may also include controllers, buffers, caches, drivers, repeaters, receivers, among other elements, to enable communication. Further, the local interface 32 may include address, control, and/or data connections to enable appropriate communications among the components 22, 24, 26, 28, 30.

It should be appreciated that the processing device 22, according to some embodiments, may include or utilize one or more generic or specialized processors (e.g., microprocessors, CPUs, Digital Signal Processors (DSPs), Network Processors (NPs), Network Processing Units (NPUs), Graphics Processing Units (GPUs), Field Programmable Gate Arrays (FPGAs), semiconductor-based devices, chips, and the like). The processing device 22 may also include or utilize stored program instructions (e.g., stored in hardware, software, and/or firmware) for control of the test system 18 by executing the program instructions to implement some or all of the functions of the systems and methods described herein. Alternatively, some or all functions may be implemented by a state machine that may not necessarily include stored program instructions, may be implemented in one or more Application Specific Integrated Circuits (ASICs), and/or may include functions that can be implemented as custom logic or circuitry. Of course, a combination of the aforementioned approaches may be used. For some of the embodiments described herein, a corresponding device in hardware (and optionally with software, firmware, and combinations thereof) can be referred to as “circuitry” or “logic” that is “configured to” or “adapted to” perform a set of operations, steps, methods, processes, algorithms, functions, techniques, etc., on digital and/or analog signals as described herein with respect to various embodiments.

The memory device 24 may include volatile memory elements (e.g., Random Access Memory (RAM), Dynamic RAM (DRAM), Synchronous DRAM (SDRAM), Static RAM (SRAM), and the like), nonvolatile memory elements (e.g., Read Only Memory (ROM), Programmable ROM (PROM), Erasable PROM (EPROM), Electrically-Erasable PROM (EEPROM), hard drive, tape, Compact Disc ROM (CD-ROM), and the like), or combinations thereof. Moreover, the memory device 24 may incorporate electronic, magnetic, optical, and/or other types of storage media. The memory device 24 may have a distributed architecture, where various components are situated remotely from one another, but can be accessed by the processing device 22.

The memory device 24 may include a data store, database (e.g., database 30), or the like, for storing data. In one example, the data store may be located internal to the test system 18 and may include, for example, an internal hard drive connected to the local interface 32 in the test system 18. Additionally, in another embodiment, the data store may be located external to the test system 18 and may include, for example, an external hard drive connected to the Input/Output (I/O) interfaces 26 (e.g., SCSI or USB connection). In a further embodiment, the data store may be connected to the test system 18 through a network and may include, for example, a network attached file server.

Software stored in the memory device 24 may include one or more programs, each of which may include an ordered listing of executable instructions for implementing logical functions. The software in the memory device 24 may also include a suitable Operating System (O/S) and one or more computer programs. The O/S essentially controls the execution of other computer programs, and provides scheduling, input/output control, file and data management, memory management, and communication control and related services. The computer programs may be configured to implement the various processes, algorithms, methods, techniques, etc. described herein.

Moreover, some embodiments may include non-transitory computer-readable media having instructions stored thereon for programming or enabling a computer, server, processor (e.g., processing device 22), circuit, appliance, device, etc. to perform functions as described herein. Examples of such non-transitory computer-readable medium may include a hard disk, an optical storage device, a magnetic storage device, a ROM, a PROM, an EPROM, an EEPROM, Flash memory, and the like. When stored in the non-transitory computer-readable medium, software can include instructions executable (e.g., by the processing device 22 or other suitable circuitry or logic). For example, when executed, the instructions may cause or enable the processing device 22 to perform a set of operations, steps, methods, processes, algorithms, functions, techniques, etc. as described herein according to various embodiments.

The methods, sequences, steps, techniques, and/or algorithms described in connection with the embodiments disclosed herein may be embodied directly in hardware, in software/firmware modules executed by a processor (e.g., processing device 22), or any suitable combination thereof. Software/firmware modules may reside in the memory device 24, memory controllers, Double Data Rate (DDR) memory, RAM, flash memory, ROM, PROM, EPROM, EEPROM, registers, hard disks, removable disks, CD-ROMs, or any other suitable storage medium.

Those skilled in the pertinent art will appreciate that various embodiments may be described in terms of logical blocks, modules, circuits, algorithms, steps, and sequences of actions, which may be performed or otherwise controlled with a general purpose processor, a DSP, an ASIC, an FPGA, programmable logic devices, discrete gates, transistor logic, discrete hardware components, elements associated with a computing device, controller, state machine, or any suitable combination thereof designed to perform or otherwise control the functions described herein.

The I/O interfaces 26 may be used to receive user input from and/or for providing system output to one or more devices or components. For example, user input may be received via one or more of a keyboard, a keypad, a touchpad, a mouse, and/or other input receiving devices. System outputs may be provided via a display device, monitor, User Interface (UI), Graphical User Interface (GUI), a printer, and/or other user output devices. I/O interfaces 26 may include, for example, one or more of a serial port, a parallel port, a Small Computer System Interface (SCSI), an Internet SCSI (ISCSI), an Advanced Technology Attachment (ATA), a Serial ATA (SATA), a fiber channel, InfiniBand, a Peripheral Component Interconnect (PCI), a PCI extended interface (PCI-X), a PCI Express interface (PCIe), an InfraRed (IR) interface, a Radio Frequency (RF) interface, and a Universal Serial Bus (USB) interface.

The network interface 28 may be used to enable the test system 18 to communicate over a network, such as the network 10, the Internet, a Wide Area Network (WAN), a Local Area Network (LAN), and the like. The network interface 28 may include, for example, an Ethernet card or adapter (e.g., 10BaseT, Fast Ethernet, Gigabit Ethernet, 10 GbE) or a Wireless LAN (WLAN) card or adapter (e.g., 802.11a/b/g/n/ac). The network interface 28 may include address, control, and/or data connections to enable appropriate communications on the network 10.

Furthermore, the test system 18 includes a troubleshooting program 34, which may be implemented in any suitable combination of hardware and/or software. In some embodiments, the troubleshooting program 34 may be implemented as software or firmware and stored on a non-transitory computer-readable medium (e.g., the memory device 24). The troubleshooting program 34 may include computer code, software, logic, etc. having instructions or directions for causing the processing device 22 to perform certain functions. For example, when executed, the troubleshooting program 34 may enable the processing device 22 to obtain, retrieve, or receive logs from the network 10 and convert the logs into standardized and structured data that can be used for troubleshooting. Then, the troubleshooting program 34 may enable the processing device 22 to latch or store the structured data (e.g., in the database 30). Then, the troubleshooting program 34 may include procedures for counting the logs, processing the logs, collating the logs, and reporting the logs as publications, notices, bulletins, posts, etc.

In some embodiments, the test system 18 (e.g., with the troubleshooting program 34) may be configured as a runtime code linting system, which may include dynamic analysis of software using log data to determine ways to improve the network 10. The test system 18 may thereby be able to verify software design correctness, optimize the software in performance, perform runtime profiling of code, perform profile-guided optimization, etc.

### Troubleshooting Program

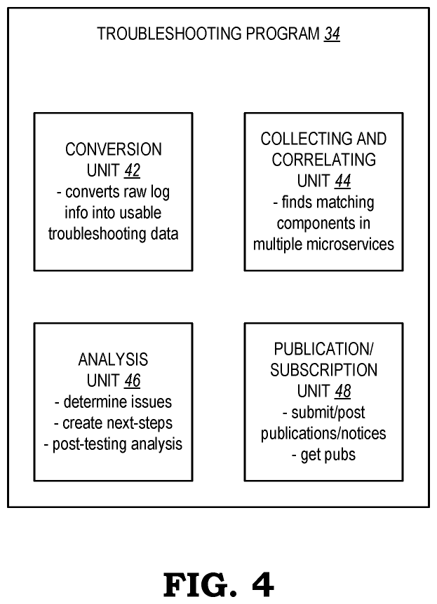

FIG. 4 is a block diagram illustrating an embodiment of the troubleshooting program 34 shown in FIG. 3. As shown in this embodiment, the troubleshooting program 34 includes a conversion unit 42, a collecting and correlating unit 44, an analysis unit 46, and a publication/subscription unit 48. For example, the conversion unit 42 may be configured to convert raw log information into usable troubleshooting data. The collecting and correlating unit 44 may be configured to find matching components in multiple other microservices to reduce redundancy in the troubleshooting processes.

The analysis unit 46 may be configured to determine issues as discovered from the logs. Also, the analysis unit 46 may be configured to create “next-steps” (e.g., instructions) for providing a blueprint for resolving the network issues. In some embodiments, the analysis unit 46 may also be configured to perform post-testing analysis to determine if any previously-executed, automatically-initiated remediation solutions for correcting the network issues were successful.

The publication/subscription unit 48 may be configured to submit, publish, or post various types of publications, notices, bulletins, reports, etc. regarding issues with certain user devices and/or microservices. This publishing step may include placing the notices or reports on a bulletin board or bulletin board system. Also, the publication/subscription unit 48 may be configured to enable certain other microservices to retrieve these notices or bulletins, as needed. For example, one or more microservices may subscribe to receive notices pertaining to other related microservices, such that, when an issue is discovered and posted by the publishing microservice, the subscribing microservice can retrieve the information and act accordingly. For example, if traffic congestion is detected with respect to one microservice, another microservice may detect this condition and delay sending traffic to that microservice or bypass the microservice.

This present disclosure provides an alternative to the conventional systems. For example, the embodiments described herein are configured to detect and notify vendors of internal system problems through structured data. Also, the present embodiments are configured to allow for transient (i.e., short-lived) problems to be “latched” and counted. The systems and methods of the present disclosure are also configured to allow test engines to collate (e.g., collect, compare, integrate, and arrange) logs in a specific order to manage these notices across all microservices. Thus, the systems and methods may roll up the logged issues into correlated system level reports that can be useful for multiple system devices, servers, and microservices throughout the network 10.

Furthermore, the present disclosure allows references to other data that can help designers troubleshoot. This can include instructions for how to change a design or options. Also, this can include additional logs collected and tagged against the notice. The present disclosure also allows microservices themselves to be notified if other dependent microservices issue notifications. This allows services (internal and external) to react to posted notices and take appropriate actions, which may include a) remedial actions intended to fix the issues, b) initiating or enabling an “enhanced data collection mode” or “debug modes” for causing the capture of a higher resolution of log information for a certain amount of time (e.g., one minute, two minutes, etc.), which may lead to the capture of messages or other recordings, c) notifying system designers via other side channels in a test infrastructure, d) automatically configuring and invoking Remote Procedure Calls (RPCs) to help the system self-heal or self-diagnose, etc.

A proposed data model, for example, may include:
+--ro bulletin
   +--ro service* [name]
      +--ro name string
      +--ro active
         +--ro notice* [id]
         +--ro id string
         +--ro value? Boolean
         +--ro severity? severity
         +--ro message? string
         +--ro action? string
         +--ro reference? string
         +--ro tracking
         +--ro first-time? ietf-yang: date-and-time
         +--ro latest-time? ietf-yang: date-and-time
         +--ro count? uint32

Because logs are usually messy and difficult to distill and coordinate without third party tools, the systems and methods of the present disclosure are configured to turn logging data into structured data that can enable ease of debugging. Once defects are placed into data, the test system 18 can watch for the next occurrence of some condition using an automated test.

By setting up a bulletin board structure with service-based notices, services can subscribe for notices from other services and take appropriate actions. For example, if service A has a notice that a queue is past a predetermined threshold, then service B could slow down or hold off on publications to service A. Furthermore, if a defect indicates that a high watermark has been passed, the next-steps could include information configured to lead automated systems to perform service analysis, execute some remote procedure calls, and reduce or change fields on the fly to self-heal the system without the need for user interaction. The results of these actions could be recorded and reported back for post testing analysis.

### References and Actions

Since the test system 18 can detect problems and report them, it is advantageous to also be able to describe the possible problems in more detail and give instructions on how to troubleshoot. For a human consumer, this may mean including a reference in the notice that directs the user to additional documentation or people that can help debug the problem found in a preproduction load. This information can be redacted and removed in a production load if it is too sensitive or irrelevant to include in possibly customer visible notices. The notice itself can also provide user instructions rather than refer to a separate document or team.

### Next Steps

Each notice may include a list of executable next-steps that is checked off by the test system 18 when execution is complete. In some cases, the notices may be given a tracking ID so that the logs can be correlated to these next-steps. Notices could be set up to report anything detectable during run time that would indicate attention from either a service developer, software developer, admin, a systems analyst, network operator, etc. or for further debugging and diagnostics during regression testing.

The next-steps actions corresponding to a notice may include things that a software developer, systems analyst, or admin could do next if this condition were to occur again. This may include checking data points, checking queue health, turning on debug logs, re-running previous config commands, etc. From a developer's perspective, it may include gathering more data. From an admin perspective, it may include performing remedial or remediation actions to recover from the diagnostic point.

### Configuration

A Notice state can be set to “acknowledged/active” or “ignored” so a system can monitor for new active notices between automated test runs. Configurations can include but are not limited to:
1) An indication, for this deployment, of whether the notice is expected or not (e.g., these notices might not be reported)
2) A mode to indicate if actions should be executed when a notice is posted (test mode)
3) Sets service data to enable/disable more verbose or debug logging
4) Internal/Remote service data retrieval
   a) “Log Once”-log and tag the log if this happens once
   b) “Log every”-log and tag the log every X times this happens or every T minutes this condition is true
5) Internal/Remote service data setting
6) Inter-service or system level view of current queue health
7) Checks if any cores are present at this point.
8) Gets/Sets that could involve run-time changes to queue sizes.
9) Clearing filesystem if there is no space.
10) Root level config data retrieval
11) Remote procedure calls
12) External actions to take
   a) Call a pager
   b) Send an email
   c) Raise a Jira (e.g., raise a request on behalf of a customer, create a ticket, etc.)
   d) Notify a Slack/Teams channel

### Bulletin Boards

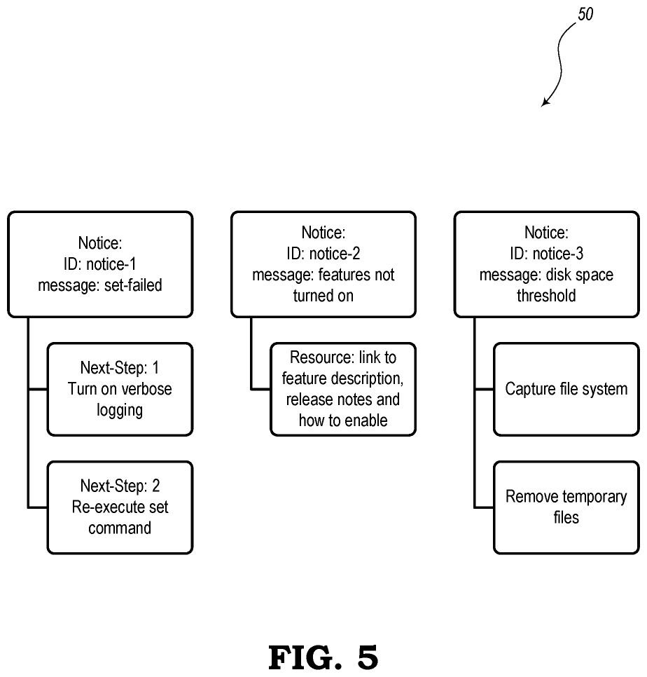

FIG. 5 is a diagram illustrating an example of a bulletin board 50 where notices can be posted. As shown, the bulletin board 50 in this example shows three notices that have been published. The first notice (ID: notice-1) includes a message about a “set-failed” issue. In this case, the set-failed issue can be resolved in two steps (or next-steps). The first step is for a technician or automated system to turn on a “verbose logging” mode, which is a mode in which enhanced data is obtained from the subject component being tested for a brief time. The enhanced data may include a higher resolution of information, additional information not normally detected in a normal mode, etc. The second step of the next-steps includes an instruction to re-execute a set command.

The second notice (ID: notice-2) posted on the bulletin board 50 in this example includes a message regarding an issue where “features are not turned on.” In this case, a resource may be available to link to feature descriptions and release notes about how to enable the features.

The third notice (ID: notice-3) posted on the bulletin board 50 in this example includes a message regarding an issue where the “disk space threshold” has been reached or surpassed. Automated remediation may include capturing a file system and removing temporary files.

The present disclosure describes systems and methods that are configured to perform modelling (e.g., ML modelling) that would augment the above diagnostics points with a next-steps list that could be executed in line with the notice becoming active. According to one example, the modelling may include:
module: ciena-common-bulletin
   +--rw next-steps [notice-id]
      +--rw notice-id string
         +--rw next-step
         +--rw data anyxml
         +--rw action string
         +--rw duration ietf-yang: date-and-time

When a particular problem is flagged, the next step could be to set the log levels to verbose for 2 minutes. This could be configured to allow the user to capture whatever is needed in real time on the system. If linked into a test runner, it could re-run. The duration between steps is also configurable so that the technician could turn something on for a period of time and then turn it off.

### Troubleshooting Method

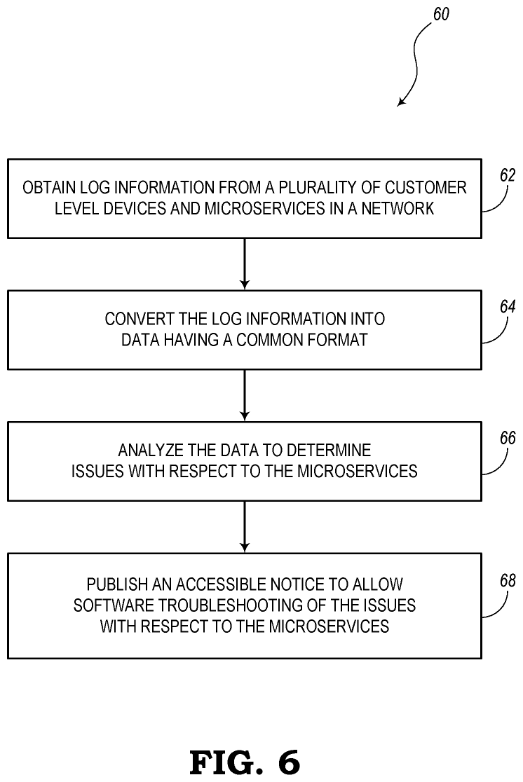

FIG. 6 is a flow diagram illustrating an embodiment of a method 60 for testing microservices of a network (e.g., network 10). In this embodiment, the method 60 includes the step of obtaining log information from a plurality of customer level devices and microservices in a network, as indicated in block 62. The method 60 further includes converting the log information into data having a common format, as indicated in block 64. Also, the method 60 includes the step of analyzing the data to determine issues with respect to the microservices, as indicated in block 66. Furthermore, the method 60 includes the step of publishing an accessible notice to allow software troubleshooting of the issues with respect to the microservices, as indicated in block 68.

According to some embodiments, the published accessible notice allows a software developer to modify software associated with one or more of the microservices to reduce the issues thereof. The step of obtaining the log information (block 62) may be performed at runtime after the microservices have been deployed in the network. The method 60 may further include the step of storing the data in a database or memory device. Note, the data can be structured or unstructured which can be turned into structured data.

The step of publishing the accessible notice (block 68) may include creating a bulletin in a bulletin board system that is accessible by other devices on the network. The bulletin board system, for example, may allow access to multiple accessible notices by one or more vendors, developers, network operators, admins, and network designers for the purpose of troubleshooting. The bulletin board system may also allow access at both a static design stage before deployment and a dynamic operational stage after deployment. The customer level devices, for example, may include one or more embedded devices.

The accessible notice described herein may also include a) instructions, b) next-steps, c) reference to additional documents or resources, d) root cause analysis, e) suggestions, and/or f) recommendations, regarding remediation of the issues with respect to the microservices. The method 60, according to some implementations, may further include the step of utilizing a tracking ID for monitoring the execution of remediation steps. The issues with respect to the microservices may include a) formatting issues, b) software bugs, c) storage or filesystem issues, d) misconfiguration issues, e) configuration reading issues, f) communication issues, g) improper use of system resources, h) issues with communicating with system resources, i) disabled system features, j) noisy log information, and/or k) irrelevant log information. The method 60 may also be configured to automatically remediate the issues with respect to the microservices.

In some embodiments, the method 60 may include the steps of 1) collating a plurality of accessible notices across multiple microservices and 2) creating a system level report. Upon detection of an issue, the method 60 may further include the step of initiating an enhanced data collection mode for obtaining log information at a greater resolution for a predetermined amount of time. In some embodiments, the method 60 may also include the step of invoking one or more Remote Procedure Calls (RPCs) from related devices to initiate self-diagnosis or self-healing stages without the need for user intervention.

### CONCLUSION

Therefore, according to various implementations, the systems and methods of the present disclosure may be configured to define a model to capture a structured view of a condition of the network. The structured view can be detected from a variety of log data by the test system 18 to create notices, reports, bulletins, etc. that are accessible from related microservices. Thus, code can be added to a networking system to detect these network conditions and report them to other subsystems or external consumers in the form of a bulletin. The systems can also add a set of subscribers or collectors to assemble, review, and correlate the notices posted as bulletins across all relevant subsystems.

Optionally, the test system 18 may include I/O interfaces 26 that may be configured to create a dashboard that a tester (e.g., technician, network operator, admin, etc.) can view. In this way, the tester can see the most important notices and act accordingly (or allow automated systems to resolve some issues). The present disclosure provides a configuration of a system that can suppress known notices in the network 10. Also, the systems and methods of the present disclosure can allow configuration of a system that can instruct the system on what actions to take if certain notices are detected in the system at runtime. These may include instructions to a) raise a Jira (or create a ticket), b) send an email or message to a user to collect more data, c) automatically escalate the log level for this condition to collect more data, d) clean up a disk, e) shutdown a service that may be causing problems, f) enable a feature, etc.

It should be noted that the systems and methods of the present disclosure provide solutions to overcome certain issues with conventional logging systems. For example, the present embodiments may be configured with an internal standardized set of diagnostic points consumable by machines and users to indicate errors, warnings, optimizations, features, and info that would normally be lost to logging systems. The present embodiments include integration between services to listen for and correlate diagnostic points at a deployment level to have a system auto synthesize root causes detected internally in a microservice deployment. The present embodiments also provide references in these raised points to log entries or documentation that can help explain user remedial action. Also, present embodiments provide explicit actions that external services can take when these points are reported to allow for the system to react to these points to either correct the problem or collect more data in a timely manner that can help humans to determine misconfiguration or system degradation.

Thus, it should be noted that the present disclosure can provide certain advantages over conventional systems. For example, the present systems and methods provide an increased ability to detect and correct problems in both a design stage (e.g., static) and in a deployment stage (e.g., dynamic). Also, the embodiments of the present disclosure allow less reliance on log subsystems, which take up space and are very hard to parse and use to find problems.

In addition, it may be noted that Nagios is a monitoring and alerting tool that is used to monitor microservices (e.g., Blue Planet microservices). It is a binary application, which means its purpose is to let the user know if a particular app is up or down. When issues do occur, they show up as alerts (OK, Warning, Unknown, and Critical). Nagios is able to send out alert notifications in the form of SNMP messages or email notifications. Nagios service checks are dynamic, which means that its checks are automatically created when new solutions are deployed and removed when solutions are undeployed.

However, it should further be noted that Nagios appears to be a standard-grade monitoring and alarm system. A key difference with the present disclosure is that the embodiments described herein are not monitoring and alarm systems per se, but rather are more like a “runtime code linting system.” One purpose of the present disclosure is to verify design correctness rather than drive operator action. In fact, the problems and actions displayed by the bulletin board system are not specifically designed to be resolvable by end user or other operators at the customer level, but rather are designed to be resolvable by software developers on a system level.

In some respect, the present disclosure may be compared with performance optimization in software. Typical C/C++ software is built with compiler optimizations turned on. These optimizations are performance improvements that the compiler can make when it can prove that the human-written code can be converted to fewer/faster machine instructions than a direct translation of the code into machine instructions would have produced. While some of these translations are quite clever and many improve performance significantly, the systems and methods of the present disclosure meet a need to focus on runtime profiling of the code to produce either human-written optimizations, further automated optimizations, and/or profile-guided optimization.

Similarly, the systems of the present disclosure may contain tools that run static analysis on the code (e.g., “lint” programs, such as Coverity). The test system 18 can functionally verify that the code works by creating tests. However, these tests might cover easily measurable properties, like functional correctness and performance. The bulletin submission, therefore, allows the present systems and methods to add runtime code checks that can flag cases where the code may be producing the correct answer to a functional test but could have been done in a better way.

For example, with a publication/subscription framework, suppose a service B can request update messages from service A about changes in data or runtime state. In many cases, the updates are periodic but not taxing on the system. However, in some cases, there may be many changes happening on the system in a short period of time and service A ends up sending a large number of messages to service B in extremely short intervals. This causes problems by maxing out the CPU just sending messages from A to B. Since sending messages is much more expensive than processing messages, the systems and methods of the present disclosure may, in some embodiments, include a “bulk update” feature which lets service A save up updates for a short period and then send many updates in a single message. This can reduce the load on the CPU at the cost of some latency between services A and B.

Nevertheless, a problem with the “bulk update” feature is that it can be difficult to tell which subscriptions should be changed just by simply looking at the code. Since some applications are sensitive to latency, it may be beneficial not to change it everywhere but there are too many subscriptions to check by hand. It also may not be evident from the code which subscriptions would benefit from the “bulk update” feature.

Thus, the solutions described in the present disclosure include the step of adding (posting) a bulletin for the cases where a system can detect too many messages sent from service A to service B in a short period of time on a running system. Since the framework knows about which service has subscribed to which data, it is possible to point out which subscription needs to change. This data can then be retrievable via the bulletin board and acted on by humans or automated systems (e.g., report a Jira, automated code refactoring systems, etc.).

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc. described herein can be used in any and all combinations with each other.

What is claimed is:

1. A test system comprising:
a processing device; and
a memory device configured to store computer logic having instructions that enable the processing device to perform the steps of
obtaining log information from a plurality of customer level devices and microservices in a network,
converting the log information into data having a common format,
analyzing the data to determine issues with respect to the microservices, and
publishing an accessible notice to allow software troubleshooting of the issues with respect to the microservices.

2. The test system of claim 1, wherein the accessible notice allows a software developer to modify software associated with one or more of the microservices to reduce the issues thereof.

3. The test system of claim 1, wherein the instructions enable the processing device to obtain the log information at runtime after the microservices have been deployed in the network.

4. The test system of claim 1, wherein the instructions further enable the processing device to store the data in a database or in the memory device.

5. The test system of claim 1, wherein the step of publishing the accessible notice includes creating a bulletin in a bulletin board system that is accessible by other devices on the network.

6. The test system of claim 5, wherein the bulletin board system allows access to multiple accessible notices by one or more vendors, developers, network operators, admins, and network designers for troubleshooting purposes.

7. The test system of claim 6, wherein the bulletin board system allows access at both a static design stage before deployment and a dynamic operational stage after deployment.

8. The test system of claim 1, wherein the plurality of customer level devices include at least one or more embedded devices.

9. The test system of claim 1, wherein the accessible notice includes one or more of a) instructions, b) next-steps, c) reference to additional documents or resources, d) root cause analysis, e) suggestions, and f) recommendations, regarding remediation of the issues with respect to the microservices.

10. The test system of claim 9, wherein the instructions further enable the processing device to perform the step of utilizing a tracking ID for monitoring execution of remediation steps.

11. The test system of claim 9, wherein the issues with respect to the microservices include one or more of a) formatting issues, b) software bugs, c) storage or filesystem issues, d) misconfiguration issues, e) configuration reading issues, f) communication issues, g) improper use of system resources, h) issues with communicating with system resources, i) disabled system features, j) noisy log information, and k) irrelevant log information.

12. The test system of claim 11, wherein the instructions further enable the processing device to automatically remediate the issues with respect to the microservices.

13. The test system of claim 1, wherein the instructions further enable the processing device to perform the steps of:
collating a plurality of accessible notices across multiple microservices; and
creating a system level report.

14. The test system of claim 1, wherein, upon detection of an issue, the instructions further enable the processing device to initiate an enhanced data collection mode for obtaining log information at a greater resolution for a predetermined amount of time.

15. The test system of claim 1, wherein the instructions further enable the processing device to invoke one or more Remote Procedure Calls (RPCs) from related devices to initiate self-diagnosis or self-healing stages without a need for user intervention.

16. A method comprising the steps of:
obtaining log information from a plurality of customer level devices and microservices in a network;
converting the log information into data having a common format;
analyzing the data to determine issues with respect to the microservices; and
publishing an accessible notice to allow software troubleshooting of the issues with respect to the microservices.

17. The method of claim 16, wherein the accessible notice allows a software developer to modify software associated with one or more of the microservices to reduce the issues thereof.

18. The method of claim 16, wherein the obtaining step is performed at runtime after the microservices have been deployed in the network.

19. The method of claim 16, further comprising the step of storing the data in a database or memory device.

20. The method of claim 16, wherein the step of publishing the accessible notice includes creating a bulletin in a bulletin board system that is accessible by other devices on the network.
